(19) United States
(12) Patent Application Publication
(10) Pub. No.: US 2011/0199450 A1
(43) Pub. Date: Aug. 18, 2011

(54) PRINTING DEVICE

(75) Inventor: Tung-Wen Tu, Taipei (TW)

(73) Assignee: PRIMAX ELECTRONICS LTD., Taipei (TW)

(21) Appl. No.: 12/785,795

(22) Filed: May 24, 2010

(30) Foreign Application Priority Data
Feb. 12, 2010 (TW) 099104590

(51) Int. Cl. B41J 2/01

(52) U.S. Cl. 347/104

(57) ABSTRACT

A printing device includes a base, a sheet pick-up module, a sheet feeding shaft and a main structural body. The main structural body includes a frame and a supporting member. The frame is fixed on the base. The supporting member is disposed on the frame for supporting the sheet pick-up module or the sheet feeding shaft. The frame is formed of an integral metal sheet part for enhancing strength of the main structural body, thereby securely fixing the components of the printing device.

### FIELD OF THE INVENTION

The present invention relates to a printing device, and more particularly to a printing device with enhanced structural strength.

### BACKGROUND OF THE INVENTION

Printing devices are essential information apparatuses in modern offices. The printing devices include for example copiers, printers, scanners and multifunction peripherals. Among these printing devices, printers are the most popular. Generally, after a printer is connected to a computer, the document file of the computer could be printed on a blank paper and then ejected out of the printer.

FIG. 1 is a schematic perspective view illustrating the outward appearance of a conventional inkjet printer. As shown in FIG. 1, the inkjet printer 1 comprises an ink cartridge 10, plural ink nozzles (not shown), a transmission mechanism 11, a sheet input tray 12 and a sheet output tray 13. The ink cartridge 10 is used for storing ink. The ink nozzles are used for ejecting ink. The ink nozzles are disposed at the bottom of the transmission mechanism 11. The transmission mechanism 11 is used for moving the ink nozzles, so that the ink could be ejected through the ink nozzles of inkjet printer 1 and printed on any position of a blank paper P. The sheet input tray 12 is used for placing the blank paper P. After an inkjet printing operation is performed, the paper P is exited to the sheet output tray 13.

During the printing process of the inkjet printer 1, the blank paper P on the sheet input tray 12 is fed into the inkjet printer 1 in a feeding direction Y, and the transmission mechanism 11 is moved in a printing direction X1 or in a printing direction X2. The printing direction X1 or the printing direction X2 is perpendicular to the feeding direction Y. After the inkjet printing operation is completed, the paper P is exited to the sheet output tray 13.

Since the inkjet printer in the office is usually used to print photographs and considered as a consumer product, it is critical to reduce the fabricating cost, increase the precision and enhance the structural strength of the inkjet printer.

FIG. 2 is a schematic partial perspective view illustrating the internal portion of the conventional inkjet printer. The internal portion of the inkjet printer 1 comprises a metal sheet part 14, a plastic part 15 and other internal components. The internal components comprise a sheet pick-up shaft (not shown), a sheet feeding shaft 16, a sheet ejecting shaft 17, and so on. The plastic part 15 is used for supporting some of the internal components (e.g. the sheet pick-up shaft). The metal sheet part 14 is a main structural body of the inkjet printer 1. The metal sheet part 14 is fixedly installed on the base 18. Some internal components (e.g. the plastic part 15, the sheet feeding shaft 16 and the sheet ejecting shaft 17) are partially enclosed by the metal sheet part 14, and thus these internal components (e.g. the plastic part 15, the sheet feeding shaft 16 and the sheet ejecting shaft 17) are fixed within the metal sheet part 14. That is, this main structural body may facilitate securely fixing the internal components of the inkjet printer 1. In addition, the rigidity of the metal sheet part may increase the structural strength of the inkjet printer 1.

Moreover, the metal sheet part 14 used as the main structural body of the inkjet printer 1 includes plural metal sheets. FIG. 3 is a schematic perspective view illustrating the metal sheet part of the main structural body of the conventional inkjet printer. As shown in FIG. 3, the metal sheet part 14 comprises a first lateral plate 140, a second lateral plate 141, a first upper frame 142 and a second upper frame 143. In addition, the first lateral plate 140, the second lateral plate 141, the first upper frame 142 and the second upper frame 143 are assembled into the metal sheet part 14 by screws 144, 145, 146, 147, 148 and 149. Since this assembling process needs an assembling jig to increase the assembling precision, this assembling process is time-consuming and costly. In addition, the main structural body of the metal sheet part 14 fails to provide enough structural strength. Since the structural strength of the inkjet printer 1 is principally provided by the screws 144, 145, 146, 147, 148 and 149 according to this assembling process, the structural strength of the inkjet printer 1 is usually insufficient.

### SUMMARY OF THE INVENTION

The present invention provides a printing device with enhanced structural strength.

In accordance with an aspect of the present invention, there is provided a printing device. The printing device includes a base, a sheet feeding channel, a sheet pick-up module, a sheet feeding shaft, an inkjet printing module, an inkjet printing module, and a main structural body. The sheet feeding channel provides a transmission path of transferring a paper. The sheet pick-up module is used for feeding the paper into the sheet feeding channel. The sheet feeding shaft is used for transferring the paper in the sheet feeding channel. The inkjet printing module is used for performing an inkjet printing operation on the paper. The main structural body includes a frame and a supporting member. The frame is fixed on the base and has a receptacle. The supporting member is disposed within the frame and fixed within the receptacle for supporting the sheet pick-up module or the sheet feeding shaft. The frame is formed of an integral one-piece metal sheet part for enhancing strength of the main structural body.

In an embodiment, the frame includes a first lateral plate, a second lateral plate and an upper plate. The first lateral plate, the second lateral plate and the upper plate collectively define the receptacle.

In an embodiment, the supporting member is made of plastic material.

In an embodiment, the printing device further includes a steering shaft for causing steering transmission of the paper in the sheet feeding channel. The steering shaft is supported by the supporting member.

In an embodiment, the printing device further includes a steering shaft for causing steering transmission of the paper in the sheet feeding channel. The steering shaft is installed on the frame and fixed within the receptacle.

In an embodiment, the printing device further includes a sheet ejecting shaft for ejecting the paper out of the sheet feeding channel. The sheet ejecting shaft is supported by the supporting member.

In an embodiment, the printing device further includes a sheet ejecting shaft for ejecting the paper out of the sheet feeding channel. The sheet ejecting shaft is installed on the frame and fixed within the receptacle.

In an embodiment, if the sheet pick-up module is supported by the supporting member, the sheet feeding shaft is installed on the frame and fixed within the receptacle.

In an embodiment, if the sheet feeding shaft is supported by the supporting member, the sheet pick-up module is installed on the frame and fixed within the receptacle.

In an embodiment, the inkjet printing module includes plural ink cartridges, an ink cartridge receiving body and a fixed shaft. The plural ink cartridges are used for storing ink. The ink cartridge receiving body is used for supporting the ink cartridges. The fixed shaft is fixed within the printing device and penetrates through the ink cartridge receiving body. The ink cartridge receiving body is movable along the fixed shaft.

In an embodiment, the printing device further includes an anti-rotation part, which is disposed on the frame and sustained against a side of the ink cartridge receiving body for preventing the ink cartridge receiving body from rotating with respect to the fixed shaft.

In an embodiment, the anti-rotation part is an L-shaped bar having a first surface and a second surface. The first surface is fixed on the frame. The second surface is sustained against the side of the ink cartridge receiving body.

In an embodiment, the anti-rotation part and the frame are formed of an integral one-piece metal sheet part.

In accordance with another aspect of the present invention, a printing device is provided. The printing device includes a base, a sheet feeding channel, a sheet pick-up module, a sheet feeding shaft, an inkjet printing module, an inkjet printing module and a main structural body. The sheet feeding channel provides a transmission path of transferring a paper. The sheet pick-up module is used for feeding the paper into the sheet feeding channel. The sheet feeding shaft is used for transferring the paper in the sheet feeding channel. The inkjet printing module is used for performing an inkjet printing operation on the paper. The main structural body includes a frame and a supporting member. The frame is fixed on the base and has a receptacle. The supporting member is disposed within the frame and fixed within the receptacle for supporting the sheet pick-up module and the sheet feeding shaft. The frame is formed of an integral one-piece metal sheet part for enhancing strength of the main structural body.

In an embodiment, the frame includes a first lateral plate, a second lateral plate and an upper plate. The first lateral plate, the second lateral plate and the upper plate collectively define the receptacle.

In an embodiment, the supporting member is made of plastic material.

In an embodiment, the printing device further includes a steering shaft for causing steering transmission of the paper in the sheet feeding channel. The steering shaft is supported by the supporting member.

In an embodiment, the printing device further includes a steering shaft for causing steering transmission of the paper in the sheet feeding channel. The steering shaft is installed on the frame and fixed within the receptacle.

In an embodiment, the printing device further includes a sheet ejecting shaft for ejecting the paper out of the sheet feeding channel. The sheet ejecting shaft is supported by the supporting member.

In an embodiment, the printing device further includes a sheet ejecting shaft for ejecting the paper out of the sheet feeding channel. The sheet ejecting shaft is installed on the frame and fixed within the receptacle.

In an embodiment, the inkjet printing module includes plural ink cartridges, an ink cartridge receiving body and a fixed shaft. The plural ink cartridges are used for storing ink. The ink cartridge receiving body is used for supporting the ink cartridges. The fixed shaft is fixed within the printing device and penetrates through the ink cartridge receiving body. The ink cartridge receiving body is movable along the fixed shaft.

In an embodiment, the printing device further includes an anti-rotation part, which is disposed on the frame and sustained against a side of the ink cartridge receiving body for preventing the ink cartridge receiving body from rotating with respect to the fixed shaft.

In an embodiment, the anti-rotation part is an L-shaped bar having a first surface and a second surface. The first surface is fixed on the frame. The second surface is sustained against the side of the ink cartridge receiving body.

In an embodiment, the anti-rotation part and the frame are formed of an integral one-piece metal sheet part.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic perspective view illustrating the outward appearance of a conventional inkjet printer;

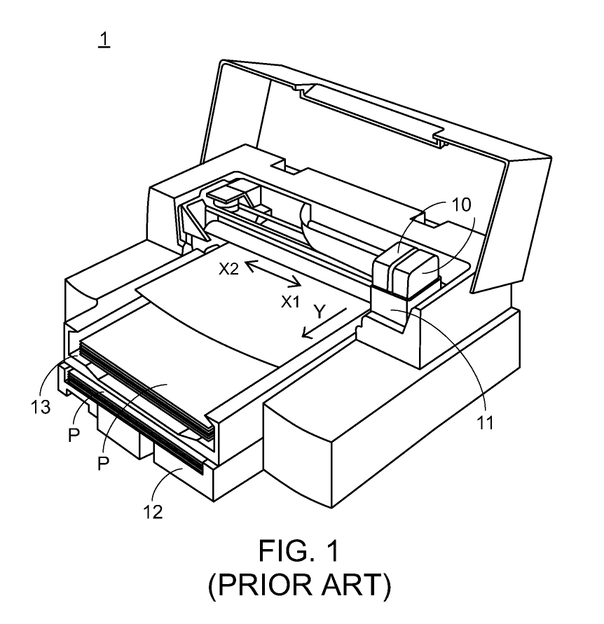

FIG. 2 is a schematic partial perspective view illustrating the internal portion of the conventional inkjet printer;

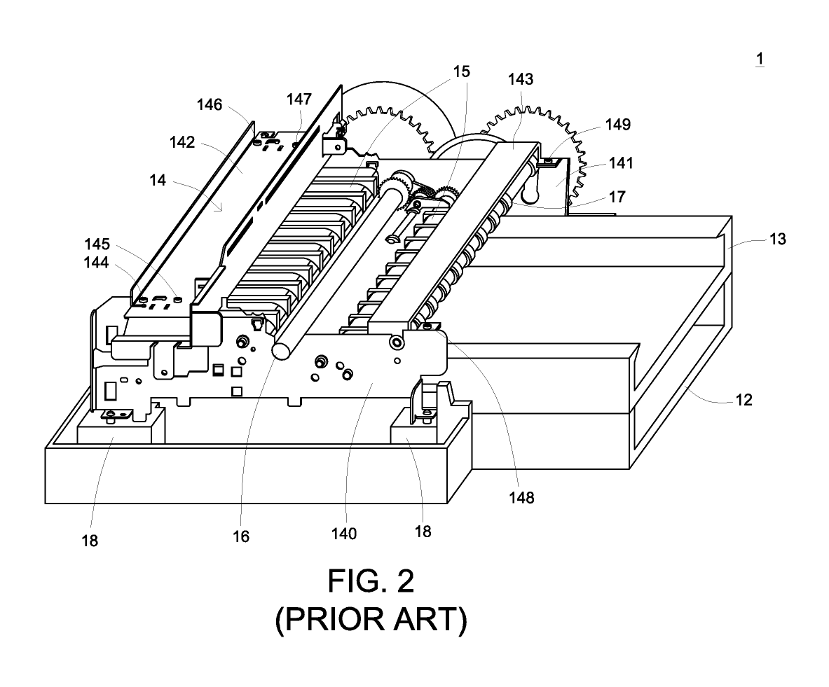

FIG. 3 is a schematic perspective view illustrating the metal sheet part of the main structural body of the conventional inkjet printer;

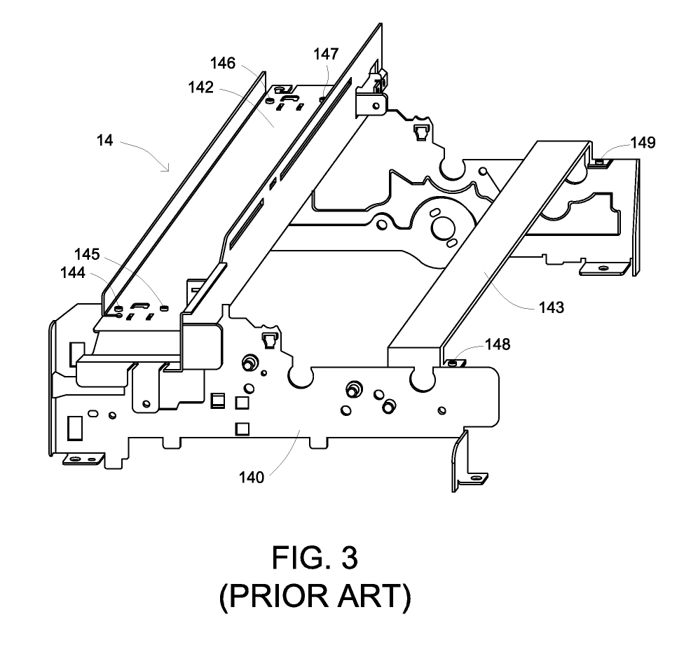

FIG. 4 is a schematic perspective view illustrating a printing device according to an embodiment of the present invention;

FIG. 5 is a schematic cutaway view illustrating a portion of the printing device as shown in FIG. 4 and taken along the cross section line L;

FIG. 6 is a schematic exploded view illustrating the internal portion of the printing device as shown in FIG. 5;

FIG. 7 is a schematic perspective view illustrating a main structural body of the printing device according to an embodiment of the present invention;

FIG. 8 is a schematic perspective view illustrating a first exemplary anti-rotation part used in the printing device of the present invention;

FIG. 9 is a schematic perspective view illustrating a second exemplary anti-rotation part used in the printing device of the present invention; and

FIG. 10 is a schematic perspective view illustrating a third exemplary anti-rotation part used in the printing device of the present invention.

### DETAILED DESCRIPTION OF THE PREFERRED EMBODIMENT

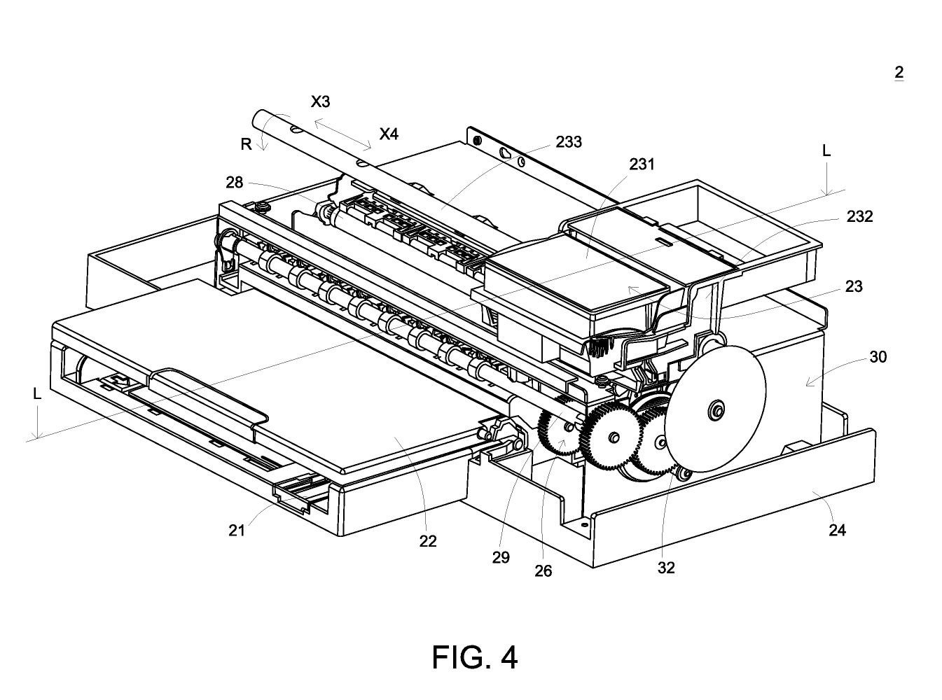

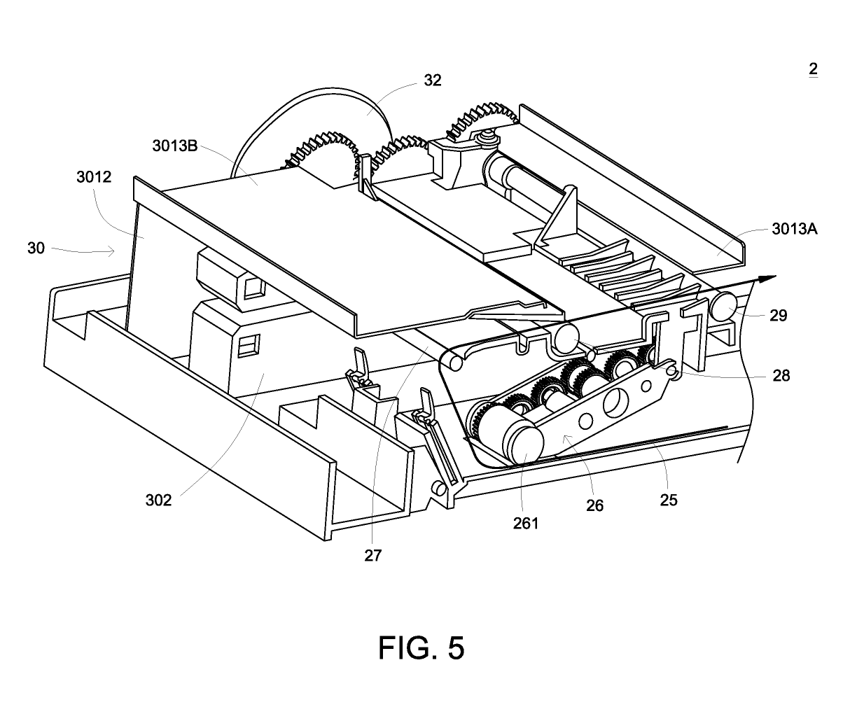

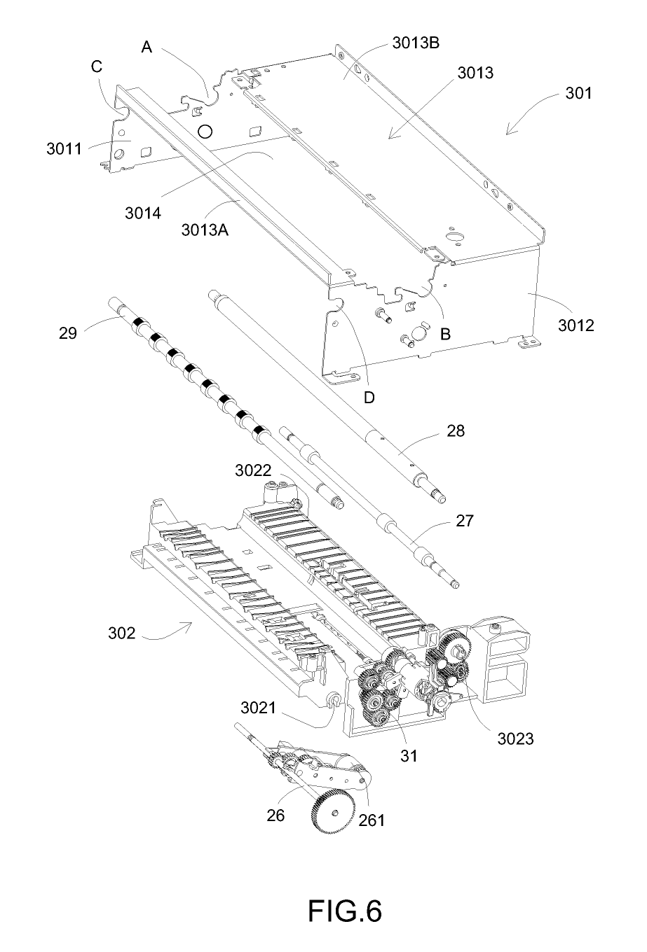

FIG. 4 is a schematic perspective view illustrating a printing device according to an embodiment of the present invention. FIG. 5 is a schematic cutaway view illustrating a portion of the printing device as shown in FIG. 4 and taken along the cross section line L. Please refer to FIGS. 4 and 5. The printing device 2 comprises a sheet input tray 21, a sheet output tray 22, an inkjet printing module 23, a base 24, a sheet feeding channel 25, a sheet pick-up module 26, a steering shaft 27, a sheet feeding shaft 28, a sheet ejecting shaft 29, a main structural body 30, a transmission gear module 31 (see FIG. 6) and a power module 32. The blank paper is placed on the sheet input tray 21, and then fed into a fixed transmission path to be printed. The printed paper is exited to and placed on the sheet output tray 22. The inkjet printing module 23 is arranged in the transmission path for ejecting ink on the blank paper, thereby printing the blank paper. The inkjet printing module 23 comprises plural ink cartridges 231 for storing ink, an ink cartridge receiving body 232 for supporting the ink cartridges 231, and a fixed shaft 233 penetrating through the ink cartridge receiving body 232. The fixed shaft 233 is fixed within the printing device 2. During the printing process, the ink cartridge receiving body 232 is moved along the fixed shaft 233 in the direction X3 or the direction X4 for ejecting ink on the blank paper.

The power module 32 is used for providing the driving force required to operate the printing device 2. The transmission gear module 31 comprises plural gears. Through the transmission gear module 31, the driving force provided by the power module 32 could be transmitted to the components that require the driving force. The components requiring the driving force include for example the sheet pick-up module 26, the steering shaft 27, the sheet feeding shaft 28, the sheet ejecting shaft 29, or the like. The sheet feeding channel 25 provides the transmission path of the printing device 2 for transferring the paper. Firstly, the paper is fed into the sheet feeding channel 25 by a sheet pick-up roller 261 of the sheet pick-up module 26. Then, the steering shaft 27 causes steering transmission of the paper. Then, the paper is transported by the sheet feeding shaft 28. Afterwards, the paper is ejected out of the sheet feeding channel 25 by the sheet ejecting shaft 29.

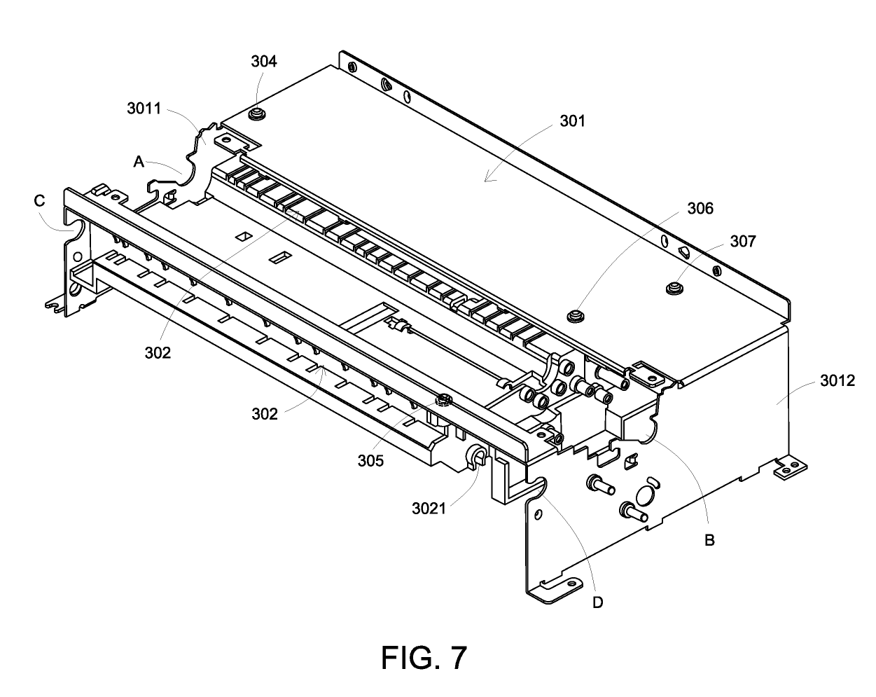

FIG. 6 is a schematic exploded view illustrating the internal portion of the printing device as shown in FIG. 5. FIG. 7 is a schematic perspective view illustrating a main structural body of the printing device according to an embodiment of the present invention. Please refer to FIGS. 6 and 7. The main structural body 30 comprises a frame 301 and a supporting member 302. The frame 301 is fixed on the base 24 (see FIG. 4). The frame 301 comprises a first lateral plate 3011, a second lateral plate 3012, and an upper plate 3013 between the first lateral plate 3011 and the second lateral plate 3012. The upper plate 3013 comprises a front upper plate 3013A and a rear upper plate 3013B. The first lateral plate 3011, the second lateral plate 3012 and the upper plate 3013 collectively define a receptacle 3014. The supporting member 302 is made of plastic material. The supporting member 302 is disposed within the frame 301 and fixed within the receptacle 3014. In this embodiment, the top surface of the supporting member 302 is fixed on the bottom surface of the upper plate 3013 by screws 304, 305, 306 and 307.

The main structural body 30 of the printing device 2 is used for securely fixing the internal structure of the printing device 2, and supporting most components of the printing device 2 (e.g. the sheet pick-up module 26, the steering shaft 27, the sheet feeding shaft 28, the sheet ejecting shaft 29, and the transmission gear module 31). In this embodiment, the sheet pick-up module 26 is installed on the bottom 3021 of the supporting member 302. The both ends of the steering shaft 27 penetrate through the circular holes 3022 and 3023, respectively, so that the steering shaft 27 is installed on the supporting member 302. The transmission gear module 31 is arranged beside the supporting member 302. In other words, at least the weights of the sheet pick-up module 26, the steering shaft 27 and the transmission gear module 31 are supported by the the supporting member 302. The both ends of the sheet feeding shaft 28 are respectively installed on the position A of the first lateral plate 3011 and the position B of the second lateral plate 3012 of the frame 301. The both ends of the sheet ejecting shaft 29 are respectively installed on the position C of the first lateral plate 3011 and the position D of the second lateral plate 3012 of the frame 301. In other words, the sheet feeding shaft 28 and the sheet ejecting shaft 29 are fixed within the receptacle 3014. It is noted that, however, those skilled in the art will readily observe that numerous modifications and alterations may be made while retaining the teachings of the invention. For example, the both ends of the sheet feeding shaft 28 may be respectively installed on two opposite sides of the supporting member 302. Alternatively, the both ends of the steering shaft 27 may be respectively installed on the first lateral plate 3011 and the second lateral plate 3012 of the frame 301. In other words, these components may be installed on the supporting member 302 and supported by the supporting member 302; or these components may be installed on the frame 301 and supported by the frame 301.

Moreover, due to the weights of the ink cartridges 231 supported by the ink cartridge receiving body 232, the ink cartridge receiving body 232 is usually tilted toward one side. As such, the ink cartridge receiving body 232 is rotated in the direction R with respect to the fixed shaft 233 (see FIG. 4). As known, during the inkjet operation is performed on the blank paper by the inkjet printing module 23, the inkjet printing module 23 should be precisely aligned. That is, the distance between the inkjet terminal and the blank paper needs to be precisely controlled. If the height of the ink cartridge receiving body 232 failed to be stably controlled or the ink cartridge receiving body 232 is rotated, the printing performance is deteriorated. For solving these problems, the printing device 2 of the present invention further comprises an anti-rotation part 33, which is disposed on the frame 301.

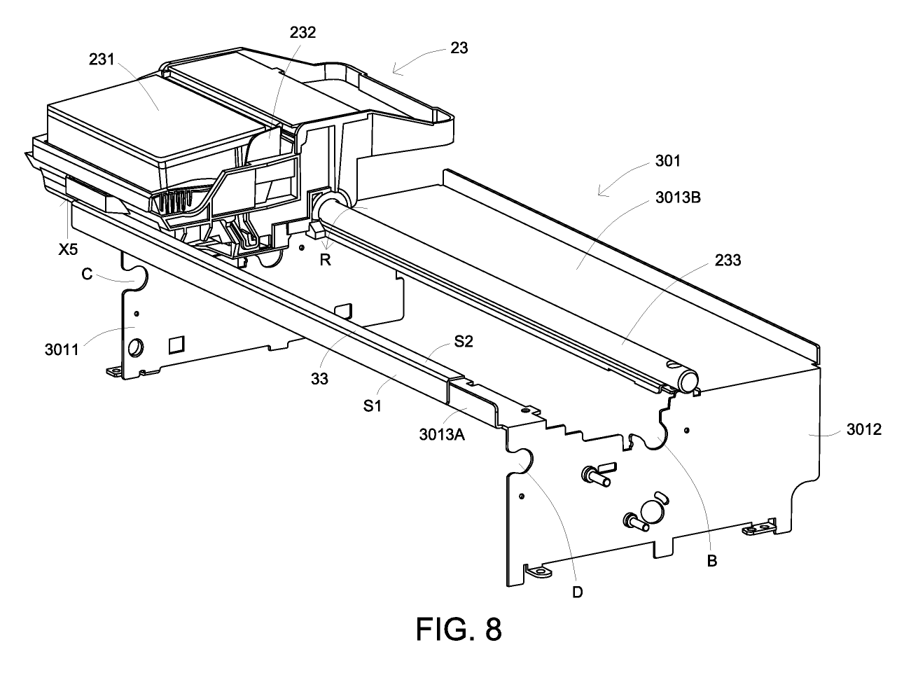

FIG. 8 is a schematic perspective view illustrating a first exemplary anti-rotation part used in the printing device of the present invention. In this embodiment, the anti-rotation part 33 is an L-shaped bar having a first rectangular surface S1 and a second rectangular surface S2. The first rectangular surface S1 is fixed on the front upper plate 3013A, and the second rectangular surface S2 is upwardly (in the direction X5) sustained against a first side of the ink cartridge receiving body 232, thereby effectively preventing the ink cartridge receiving body 232 from rotating in the direction R with respect to the fixed shaft 233.

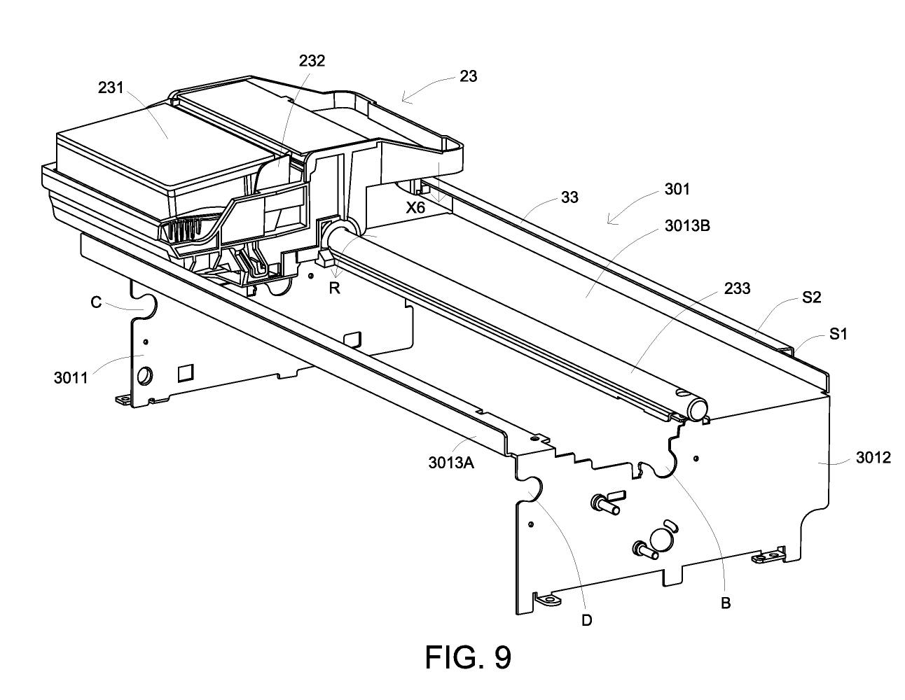

FIG. 9 is a schematic perspective view illustrating a second exemplary anti-rotation part used in the printing device of the present invention. In this embodiment, the anti-rotation part 33 is also an L-shaped bar having a first rectangular surface S1 and a second rectangular surface S2. The first rectangular surface S1 is fixed on the rear upper plate 3013B. The second rectangular surface S2 is downwardly (in the direction X6) sustained against a second side of the ink cartridge receiving body 232, thereby effectively preventing the ink cartridge receiving body 232 from rotating in the direction R with respect to the fixed shaft 233.

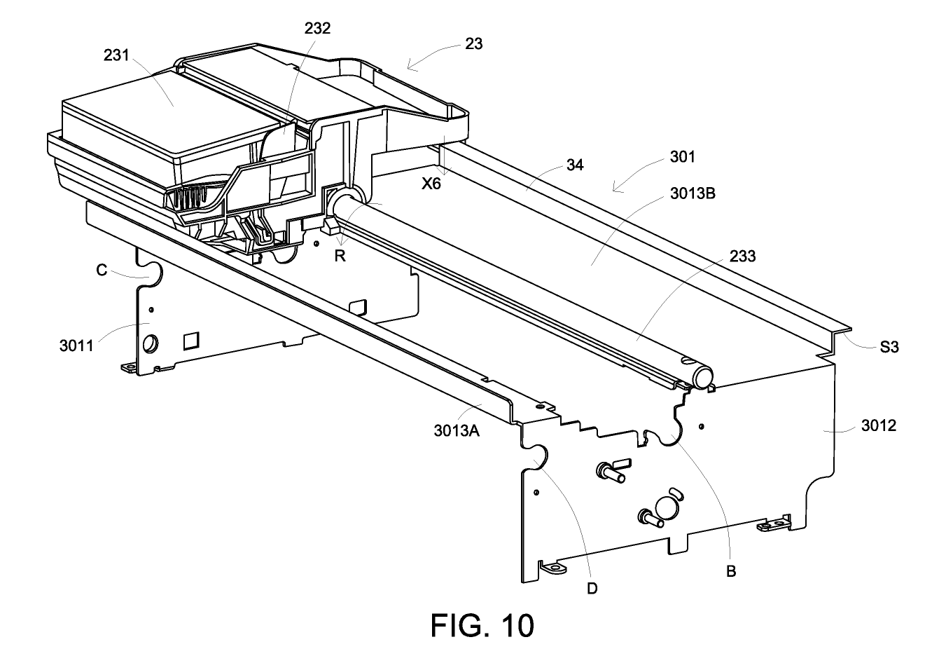

FIG. 10 is a schematic perspective view illustrating a third exemplary anti-rotation part used in the printing device of the present invention. In this embodiment, the anti-rotation part 34 has an elongated shape and is integrally formed on the rear upper plate 3013B. The rectangular surface S3 is downwardly (in the direction X6) sustained against a second side of the ink cartridge receiving body 232, thereby effectively preventing the ink cartridge receiving body 232 from rotating in the direction R with respect to the fixed shaft 233.

The spirit of the present invention will be summarized as follows. Since the top surface of the supporting member 302 is fixed on the bottom surface of the upper plate 3013 of the frame 301, the frame 301 needs to withstand the weight of the supporting member 302. In addition, regardless of whether the components are installed on the supporting member 302 or the frame 301, the frame 301 still needs to withstand the overall weight. In accordance with a key feature of the present invention, the frame 301 of the printing device 2 of the present invention is formed of an integral one-piece metal sheet part. In addition, the first lateral plate 3011, the second lateral plate 3012 and the upper plate 3013 are integrally connected with each other without using the rivet connecting manner or the screw connecting manner. As a consequence, the strength of the main structural body 30 is largely enhanced and sufficient to withstand most components of the printing device 2. Moreover, since the main structural body 30 is enhanced and the anti-rotation part 33 is disposed on the front upper plate 3013A or the rear upper plate 3013B, the anti-rotation part 33 can be securely sustained against the ink cartridge receiving body 232. In this situation, the inkjet printing module 23 can be precisely aligned during the inkjet operation in progress. Moreover, the anti-rotation part 33 may be additionally disposed on the frame 301; or otherwise the anti-rotation part 33 may be integrally formed with the frame 301 by means of a single integral metal sheet part. Since the frame is formed of the integral one-piece metal sheet part, no assembling jig is needed. In this situation, the assembling error is reduced, the fabricating time is saved, and the printing device 2 has increased mechanical precision.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A printing device, comprising:
a base;
a sheet feeding channel for providing a transmission path of transferring a paper;
a sheet pick-up module for feeding said paper into said sheet feeding channel;
a sheet feeding shaft for transferring said paper in said sheet feeding channel;
an inkjet printing module for performing an inkjet printing operation on said paper; and
a main structural body comprising a frame and a supporting member, wherein said frame is fixed on said base and has a receptacle, said supporting member is disposed within said frame and fixed within said receptacle for supporting said sheet pick-up module or said sheet feeding shaft, and said frame is formed of an integral one-piece metal sheet part for enhancing strength of said main structural body.

2. The printing device according to claim 1 wherein said frame comprises a first lateral plate, a second lateral plate and an upper plate, wherein said first lateral plate, said second lateral plate and said upper plate collectively define said receptacle.

3. The printing device according to claim 1 wherein said supporting member is made of plastic material.

4. The printing device according to claim 1 wherein said printing device further comprises a steering shaft for causing steering transmission of said paper in said sheet feeding channel, wherein said steering shaft is supported by said supporting member.

5. The printing device according to claim 1 wherein said printing device further comprises a steering shaft for causing steering transmission of said paper in said sheet feeding channel, wherein said steering shaft is installed on said frame and fixed within said receptacle.

6. The printing device according to claim 1 wherein said printing device further comprises a sheet ejecting shaft for ejecting said paper out of said sheet feeding channel, wherein said sheet ejecting shaft is supported by said supporting member.

7. The printing device according to claim 1 wherein said printing device further comprises a sheet ejecting shaft for ejecting said paper out of said sheet feeding channel, wherein said sheet ejecting shaft is installed on said frame and fixed within said receptacle.

8. The printing device according to claim 1 wherein if said sheet pick-up module is supported by said supporting member, said sheet feeding shaft is installed on said frame and fixed within said receptacle.

9. The printing device according to claim 1 wherein if said sheet feeding shaft is supported by said supporting member, said sheet pick-up module is installed on said frame and fixed within said receptacle.

10. The printing device according to claim 1 wherein inkjet printing module comprises:
plural ink cartridges for storing ink;
an ink cartridge receiving body for supporting said ink cartridges; and
a fixed shaft fixed within said printing device and penetrating through said ink cartridge receiving body, wherein said ink cartridge receiving body is movable along said fixed shaft.

11. The printing device according to claim 10 wherein said printing device further comprises an anti-rotation part, which is disposed on said frame and sustained against a side of said ink cartridge receiving body for preventing said ink cartridge receiving body from rotating with respect to said fixed shaft.

12. The printing device according to claim 11 wherein said anti-rotation part is an L-shaped bar having a first surface and a second surface, wherein said first surface is fixed on said frame, and said second surface is sustained against said side of said ink cartridge receiving body.

13. The printing device according to claim 11 wherein said anti-rotation part and said frame are formed of an integral one-piece metal sheet part.

14. A printing device, comprising:
a base;
a sheet feeding channel for providing a transmission path of transferring a paper;
a sheet pick-up module for feeding said paper into said sheet feeding channel;
a sheet feeding shaft for transferring said paper in said sheet feeding channel;
an inkjet printing module for performing an inkjet printing operation on said paper; and
a main structural body comprising a frame and a supporting member, wherein said frame is fixed on said base and has a receptacle, said supporting member is disposed within said frame and fixed within said receptacle for supporting said sheet pick-up module and said sheet feeding shaft, and said frame is formed of an integral one-piece metal sheet part for enhancing strength of said main structural body.

15. The printing device according to claim 14 wherein said frame comprises a first lateral plate, a second lateral plate and an upper plate, wherein said first lateral plate, said second lateral plate and said upper plate collectively define said receptacle.

16. The printing device according to claim 14 wherein said supporting member is made of plastic material.

17. The printing device according to claim 14 wherein said printing device further comprises a steering shaft for causing steering transmission of said paper in said sheet feeding channel, wherein said steering shaft is supported by said supporting member.

18. The printing device according to claim 14 wherein said printing device further comprises a steering shaft for causing steering transmission of said paper in said sheet feeding channel, wherein said steering shaft is installed on said frame and fixed within said receptacle.

19. The printing device according to claim 14 wherein said printing device further comprises a sheet ejecting shaft for ejecting said paper out of said sheet feeding channel, wherein said sheet ejecting shaft is supported by said supporting member.

20. The printing device according to claim 14 wherein said printing device further comprises a sheet ejecting shaft for ejecting said paper out of said sheet feeding channel, wherein said sheet ejecting shaft is installed on said frame and fixed within said receptacle.

21. The printing device according to claim 14 wherein inkjet printing module comprises:
plural ink cartridges for storing ink;
an ink cartridge receiving body for supporting said ink cartridges; and
a fixed shaft fixed within said printing device and penetrating through said ink cartridge receiving body, wherein said ink cartridge receiving body is movable along said fixed shaft.

22. The printing device according to claim 21 wherein said printing device further comprises an anti-rotation part, which is disposed on said frame and sustained against a side of said ink cartridge receiving body for preventing said ink cartridge receiving body from rotating with respect to said fixed shaft.

23. The printing device according to claim 22 wherein said anti-rotation part is an L-shaped bar having a first surface and a second surface, wherein said first surface is fixed on said frame, and said second surface is sustained against said side of said ink cartridge receiving body.

24. The printing device according to claim 21 wherein said anti-rotation part and said frame are formed of an integral metal sheet part.
